(19) United States
(12) Patent Application Publication
(10) Pub. No.: US 2014/0203490 A1
(43) Pub. Date: Jul. 24, 2014

(54) IMAGE PROCESSING APPARATUS, PRINTING CONTROL APPARATUS, INFORMATION PROCESSING APPARATUS, CONTROL METHOD, AND STORAGE MEDIUM

(71) Applicant: CANON KABUSHIKI KAISHA, Tokyo (JP)

(72) Inventor: Satoshi Totsuka, Kawasaki-shi (JP)

(73) Assignee: CANON KABUSHIKI KAISHA, Tokyo (JP)

(21) Appl. No.: 14/161,370

(22) Filed: Jan. 22, 2014

(30) Foreign Application Priority Data
Jan. 24, 2013 (JP) 2013-011137

(51) Int. Cl. B41J 13/00

(52) U.S. Cl. CPC B41J 13/0009
USPC 270/1.01

(57) ABSTRACT

An image processing apparatus, which is configured to print an image on a sheet and perform binding processing for binding a plurality of sheets, includes a specifying unit configured to specify a sheet to be used for printing, and a notification unit configured to notify a user of a sheet for which a maximum number of sheets that are bindable by the binding processing is greater than or equal to that for the sheet specified by the specifying unit.

### BACKGROUND OF THE INVENTION

1. Field of the Invention

The present invention relates to an image processing apparatus configured to print an image on a sheet and bind a plurality of sheets. Further, the present invention relates to a printing control apparatus configured to control a printing unit configured to print an image on a sheet and a binding unit configured to bind a plurality of sheets. Further, the present invention relates to an information processing apparatus configured to transmit print data to the image processing apparatus.

2. Description of the Related Art

There are image processing apparatuses configured to print an image on a sheet and cause a sheet processing apparatus to bind a plurality of sheets with images printed thereon. A representative example of binding processing is staple binding processing. In the staple binding processing, a plurality of sheets is bound with use of metal staples.

As a method for binding a plurality of sheets without use of staples, there is a method in which a plurality of sheets is collectively cut out as if they are bored, and tips of the cut pieces are weaved onto each other, as discussed in Japanese Patent Application Laid-Open No. 8-300847. In addition, there are a method in which a plurality of sheets is glued together and a method in which a special blade is pressed against a plurality of sheets to fasten the plurality of sheets to one another.

Regarding the binding processing for binding a plurality of sheets without use of a stable, a binding force generated thereby is weak, and a maximum number of sheets that are bindable thereby is small, compared to the binding processing for binding a plurality of sheets with use of staples. Further, the maximum number of sheets that are bindable (hereinafter referred to as a maximum number of bindable sheets) and the strength for binding sheets (hereinafter referred to as a binding strength) vary depending on a type of sheets (for example, a paper type), a weight of sheets (for example, a grammage), and the like. On the other hand, the binding processing for binding sheets without use of staples has such advantages that this processing can save resources because no staple is used, and allows print products to be discarded without requiring removal of staples. A user selectively employs the binding processing for binding sheets with use of staples and the binding processing for binding sheets without use of staples according to his/her intended purpose.

However, the user may select sheets to be used for printing without knowing the fact that the maximum number of bindable sheets and the binding strength vary depending on a type of sheets, a weight of sheets, and the like.

For example, suppose that the maximum number of sheets that are bindable without use of staples is eleven for plain paper while the maximum number of sheets that are bindable without use of staples is seven for thick paper, and both the plain paper and the thick paper are set on an image processing apparatus. Even though the plain paper, for which the maximum number of sheets that are bindable is greater, is set on the image processing apparatus, the user may use the thick paper for printing without knowing this fact if the thick paper is specified by default or the thick paper is specified by the user.

### SUMMARY OF THE INVENTION

The present invention is directed to an image processing apparatus that allows a user to confirm that there is another sheet type corresponding to a greater or equal maximum number of bindable sheets or a greater or equal binding strength.

According to an aspect of the present invention, an image processing apparatus that prints an image on a sheet and controls a binding unit to bind a plurality of sheets includes a printing unit configured to print an image on a sheet, a control unit configured to control the binding unit to perform binding processing for binding a plurality of sheets on which images are printed by the printing unit, a specifying unit configured to specify a sheet to be used for printing, and a notification unit configured to notify a user of a sheet for which a maximum number of sheets that are bindable by the binding processing is greater than or equal to that for the sheet specified by the specifying unit.

According to another aspect of the present invention, an image processing apparatus that prints an image on a sheet and controls a binding unit to bind a plurality of sheets includes a printing unit configured to print an image on a sheet, a control unit configured to control the binding unit to perform binding processing for binding a plurality of sheets on which images are printed by the printing unit, a specifying unit configured to specify a sheet to be used for printing, and a notification unit configured to notify a user of a sheet for which a binding strength by the binding processing is greater than or equal to that for the sheet specified by the specifying unit.

According to yet another aspect of the present invention, a printing control apparatus that controls a printing unit configured to print an image on a sheet and a binding unit configured to bind a plurality of sheets includes a control unit configured to control the printing unit to print an image on a sheet and control the binding unit to perform binding processing for binding a plurality of sheets on which images are printed by the printing unit, a specifying unit configured to specify a sheet to be used for printing, and a notification unit configured to notify a user of a sheet for which at least one of a maximum number of sheets that are bindable by the binding processing and a binding strength by the binding processing is greater than or equal to that for the sheet specified by the specifying unit.

According to yet another aspect of the present invention, an information processing apparatus that transmits print data to an image processing apparatus configured to print an image on a sheet and bind a plurality of sheets includes a transmission unit configured to transmit print data for printing an image on a sheet and performing binding processing for binding a plurality of sheets on which images are printed to the image processing apparatus, a specifying unit configured to specify a sheet to be used for printing, and a notification unit configured to notify a user of a sheet for which at least one of a maximum number of sheets that are bindable by the binding processing and a binding strength by the binding processing is greater than or equal to that for the sheet specified by the specifying unit.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image processing apparatus.

FIG. 2 is a cross-sectional view of the image processing apparatus.

FIGS. 3A and 3B illustrate second binding processing performed by a second binding unit.

FIG. 4 illustrates a cross-section of a plurality of bound sheets.

FIG. 5 illustrates the plurality of bound sheets as viewed from above.

FIG. 6 illustrates an example of a user interface screen displayed on an operation unit.

FIG. 7 illustrates an example of a user interface screen displayed on the operation unit.

FIG. 8 is a flowchart illustrating a control method for controlling execution of copying.

FIG. 9 is a flowchart illustrating the control method for controlling execution of copying.

FIG. 10 is a flowchart illustrating the control method for controlling execution of copying.

FIG. 11 illustrates an example of a user interface screen displayed on the operation unit.

FIG. 12 illustrates an example of a user interface screen displayed on the operation unit.

FIG. 13 illustrates an example of a user interface screen displayed on the operation unit.

FIG. 14 illustrates an example of a user interface screen displayed on the operation unit.

FIG. 15 illustrates an example of a user interface screen displayed on the operation unit.

FIG. 16 is a flowchart illustrating a method for searching for a sheet feeding unit.

FIGS. 17A and 17B illustrate two tables used in the method for searching for a sheet feeding unit.

FIG. 18 is a block diagram illustrating a configuration of an information processing apparatus according to an exemplary embodiment of the present invention.

FIG. 19 is a flowchart illustrating a control method for transmitting print data to the image processing apparatus.

FIG. 20 illustrates an example of a user interface screen displayed on a display.

FIG. 21 illustrates an example of a user interface screen displayed on the display.

FIG. 22 illustrates an example of a user interface screen displayed on the display.

### DESCRIPTION OF THE EMBODIMENTS

Various exemplary embodiments, features, and aspects of the invention will be described in detail below with reference to the drawings.

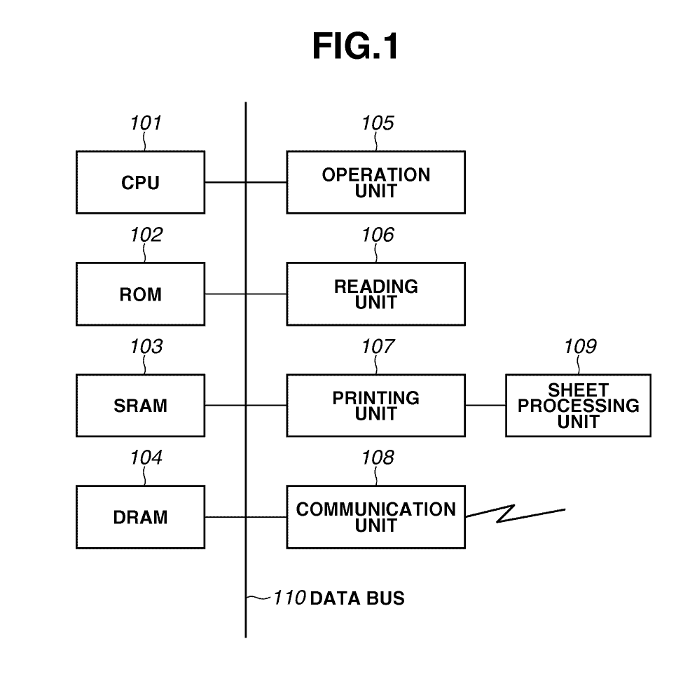

FIG. 1 is a block diagram illustrating a configuration of an image processing apparatus according to a first exemplary embodiment. The image processing apparatus has a reading function of reading an image on a sheet, and a printing function of printing an image on a sheet. A sheet processing apparatus is connected to the image processing apparatus, and has a post-processing function of binding a plurality of sheets and folding a sheet. FIG. 1 illustrates an example in which the image processing apparatus includes the sheet processing apparatus as a sheet processing unit. However, the sheet processing apparatus may be detachably attached to the image processing apparatus. The sheet includes a paper sheet such as plain paper and thick paper, an overhead projector (OHP) sheet, and the like.

A central processing unit (CPU) 101 is a control unit of the image processing apparatus. The CPU 101 controls the whole image processing apparatus by executing a program. A read only memory (ROM) 102 stores the control program that the CPU 101 can execute. A static random access memory (SRAM) 103 stores setting values registered by a user and management data of the image processing apparatus, and functions as a buffer for work of the CPU 101. The SRAM 103 can be driven by a battery, and is a nonvolatile memory. Even when the image processing apparatus is powered off, information stored in the SRAM 103 is not lost. A dynamic random access memory (DRAM) 104 stores control variables of the program that is executed by the CPU 101. The SRAM 103 may be replaced with a hard disk drive (HDD) depending on the type of the image processing apparatus. Further, a hard disk drive may be provided to the image processing apparatus together with the SRAM 103.

An operation unit 105 displays information to the user and inputs an instruction from the user. Therefore, the operation unit 105 includes a touch panel display and a start button. The touch panel display displays user interface screens, which will be described below. The user presses a key displayed on the touch panel display using a touch panel. The operation unit 105 may include a display and various kinds of hard keys instead of the touch panel display. In this case, the user presses a key displayed on the display using the hard key.

The operation unit 105 displays various kinds of information to notify the user of these kinds of information. Further, if the operation unit 105 includes a speaker, the operation unit 105 may notify the user of these kinds of information with a sound.

A reading unit 106 reads an image on a sheet and converts this image into image data such as binary data. The image data generated by the reading unit 106 is stored in the SRAM 103. After that, the image data is transmitted to an external apparatus by a communication unit 108, or is printed on a sheet. A printing unit 107 prints an image based on the image data onto a sheet. For a copying function, the reading unit 106 reads an image on a sheet to generate image data, and the printing unit 107 prints an image based on the image data onto another sheet.

The communication unit 108 transmits the image data to an external apparatus, and receives image data from the external apparatus. The communication unit 108 communicates with an external apparatus via a network such as a wired local area network (LAN) or a wireless LAN, communicates with an external apparatus via a local interface such as a universal serial bus (USB), and communicates with an external facsimile apparatus via a telephone line. The image data received by the communication unit 108 is stored in the SRAM 103.

A data bus 110 transfers the image data and a control signal among the above-described devices.

The printing unit 107 is connected to a sheet processing unit 109, and conveys a printed sheet to the sheet processing unit 109. The sheet processing unit 109 receives a control command from the CPU 101 via the printing unit 107, and performs post-processing on the sheet according to this control command. For example, the sheet processing unit 109 aligns a plurality of sheets with one another, distributes a plurality of sheets among a plurality of trays, and binds a plurality of sheets. According to the present exemplary embodiment, the sheet processing unit 109 can perform at least one of first binding processing for binding a plurality of sheets with use of staples, and second binding processing for binding a plurality of sheets without use of staples.

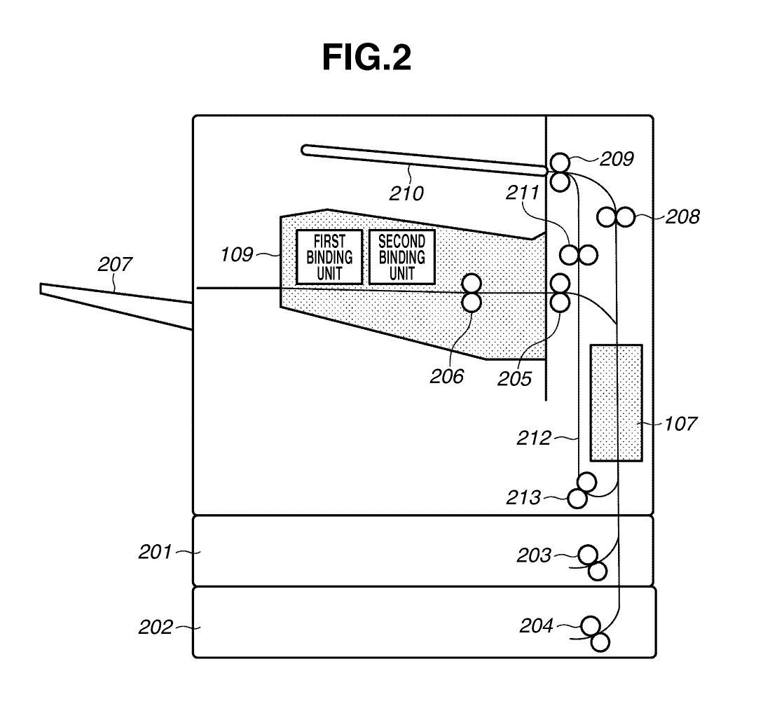

FIG. 2 is a cross-sectional view of the image processing apparatus. FIG. 2 will be described now while omitting the descriptions of the CPU 101, the ROM 102, the SRAM 103, the DRAM 104, the operation unit 105, the reading unit 106, and the communication unit 108.

In an example illustrated in FIG. 2, the sheet processing unit 109 is disposed within a housing of the image processing apparatus. However, the location of the sheet processing unit 109 is not limited to the example illustrated in FIG. 2. The sheet processing unit 109 may be connected so as to be located adjacent to the image processing apparatus.

A sheet feeding unit 201 and a sheet feeding unit 202 store sheets, respectively. In the example illustrated in FIG. 2, the image processing apparatus includes two sheet feeding units, but the number of sheet feeding units is not limited to two. Conveyance rollers 203 convey a sheet stored in the sheet feeding unit 201 to the printing unit 107. Further, conveyance rollers 204 convey a sheet stored in the sheet feeding unit 202 to the printing unit 107. The printing unit 107 prints an image on a first surface of the conveyed sheet. The printing unit 107 may employ the inkjet method, according to which the printing unit 107 prints an image by spraying ink onto the sheet, or the electrophotographic method, according to which the printing unit 107 prints an image by fixing toner onto the sheet.

At the time of one-sided printing, the printed sheet is guided to conveyance rollers 205, and the conveyance rollers 205 convey the sheet to the sheet processing unit 109. Conveyance rollers 206 convey the sheet to the first binding unit or the second binding unit.

In the example illustrated in FIG. 2, the sheet processing unit 109 includes two binding units arranged side by side. A first binding unit is called a stapler, which binds a plurality of sheets with use of metal staples. A second binding unit binds a plurality of sheets without use of staples. The details of the second binding unit will be described below. Each of a plurality of sheets is conveyed to the sheet processing unit 109, and the sheet processing unit 109 holds the plurality of sheets. The first binding unit or the second binding unit binds the plurality of held sheets. In the example illustrated in FIG. 2, the sheet processing unit 109 includes the first binding unit and the second binding unit, but the sheet processing unit 109 may include only the second binding unit.

The sheets are discharged onto a sheet discharge unit 207, after being conveyed through the sheet processing unit 109.

At the time of two-sided printing, the printed sheet is guided to conveyance rollers 208, and the conveyance rollers 208 convey the sheet to conveyance rollers 209. The conveyance rollers 209 convey the sheet to a reverse path 210. Once the trailing edge of the sheet reaches the conveyance rollers 209, the conveyance rollers 209 start rotating in a reverse direction and convey the sheet to conveyance rollers 211. The conveyance rollers 211 convey the sheet to conveyance rollers 213 via a two-sided printing conveyance path 212. The conveyance rollers 213 convey the sheet to the printing unit 107. The printing unit 107 prints an image onto a second surface of the sheet. The sheet with images printed on the both surfaces is guided to the conveyance rollers 205. The conveyance rollers 205 convey the sheet to the sheet processing unit 109.

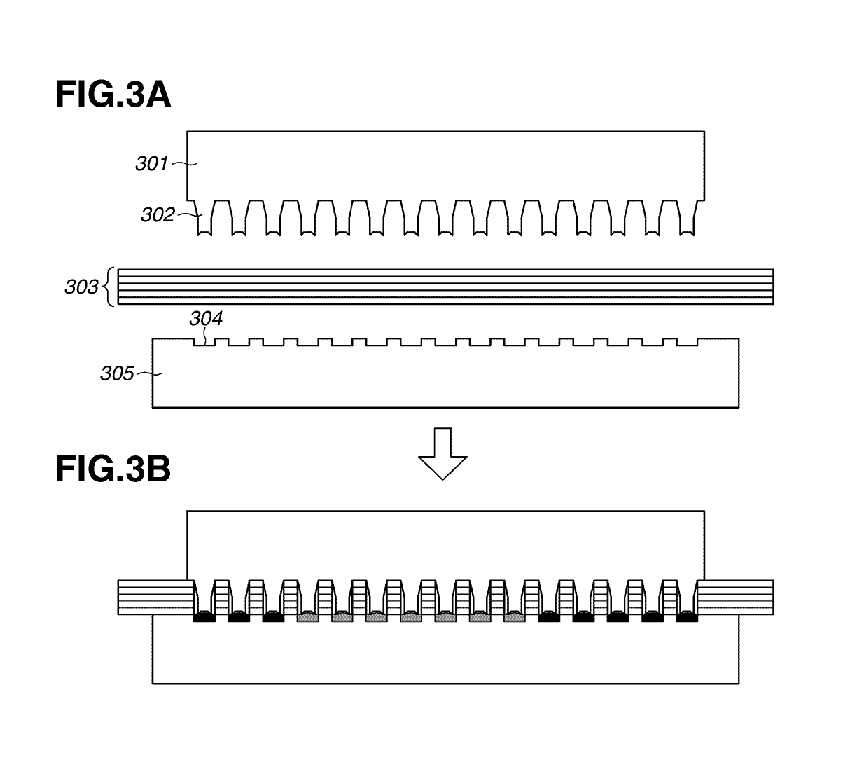

FIGS. 3A and 3B illustrate the second binding processing performed by the second binding unit. In the second binding processing, the second binding unit applies a pressure onto a plurality of sheets from above and below to set them into close contact to one another, thereby binding them. FIG. 3A illustrates that the plurality of sheets is set at a binding position, and the second binding unit has moved to the binding position.

In FIG. 3A, the plurality of sheets 303 is about to be bound. An upper die 301 presses the plurality of sheets 303 from above. A plurality of convex blades 302 is lined up on the upper die 301, and each blade 302 applies a pressure onto the sheets 303. A lower die 305 presses the plurality of sheets 303 from below. A plurality of recessed portions 304 corresponding to the plurality of blades 302 is lined up on the lower die 305, and the respective recessed portions 304 receive the blades 302.

FIG. 3B illustrates that the upper die 301 and the lower die 305 press the plurality of sheets 303 from above and below. The upper die 301 and the lower die 305 press the plurality of sheets 303, thereby enabling the second binding unit to bind the plurality of sheets 303. The plurality of blades 302 and the plurality of recessed portions 304 press a plurality of positions on the sheets 303, thereby preventing the sheets 303 from being easily separated from one another.

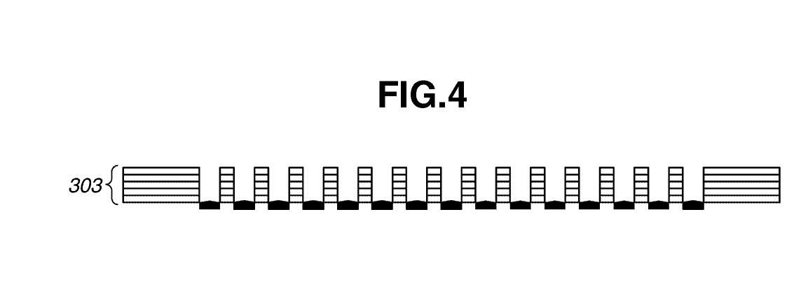

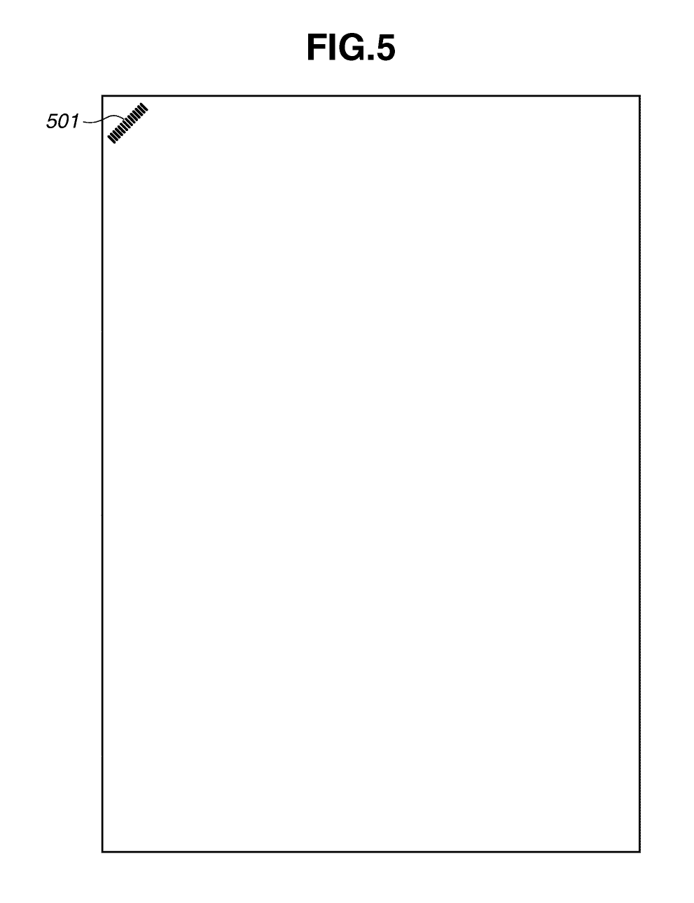

FIG. 4 illustrates a cross-section of a bound position. FIG. 5 illustrates the plurality of bound sheets 303 as viewed from above. The plurality of bound sheets 303 has the bound position 501. At the bound position 501, the plurality of sheets 303 is pressed to be squeezed by the blades 302 and the recessed portions 304, thereby being bound. The second binding processing binds a plurality of sheets by pressing them, whereby the number of sheets that are bindable by the second binding processing is less than the number of sheets that are bindable by the first binding processing.

In a case where the image processing apparatus can perform each of the first binding processing and the second binding processing, the user can select which binding processing the user wants to perform.

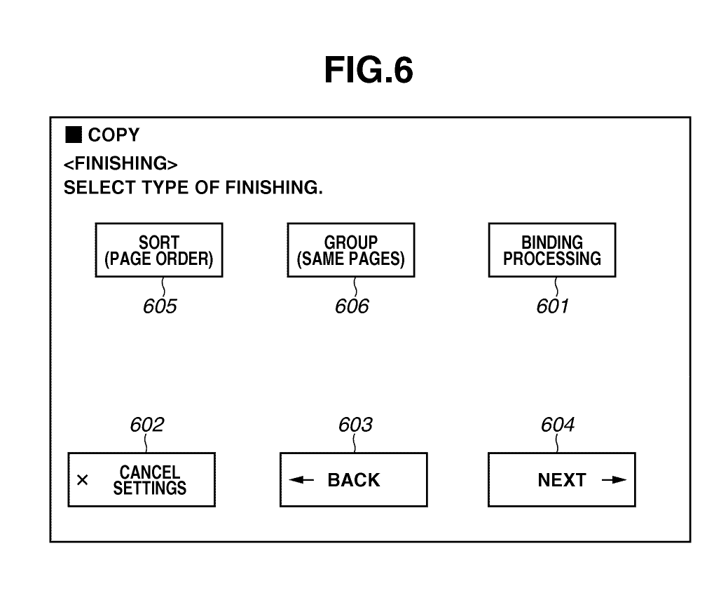

FIG. 6 illustrates an example of a user interface screen displayed on the operation unit 105. The user sets finishing at the time of copying on the user interface screen illustrated in FIG. 6. In the case where the image processing apparatus can perform each of the first binding processing and the second binding processing, the user's pressing of a key 601 causes a user interface screen that allows the user to select a type of the binding processing to be displayed on the operation unit 105.

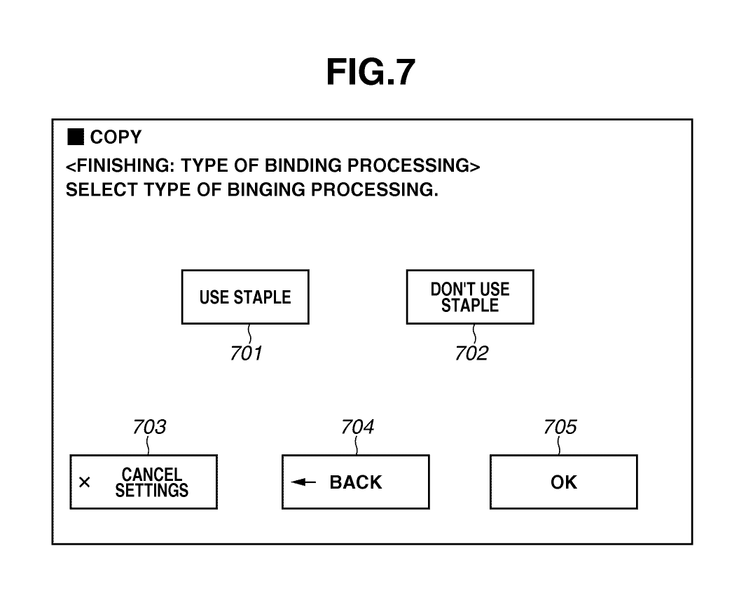

FIG. 7 illustrates an example of the user interface screen that allows the user to select a type of the binding processing. A key 701 is a key for selecting the first binding processing, and a key 702 is a key for selecting the second binding processing.

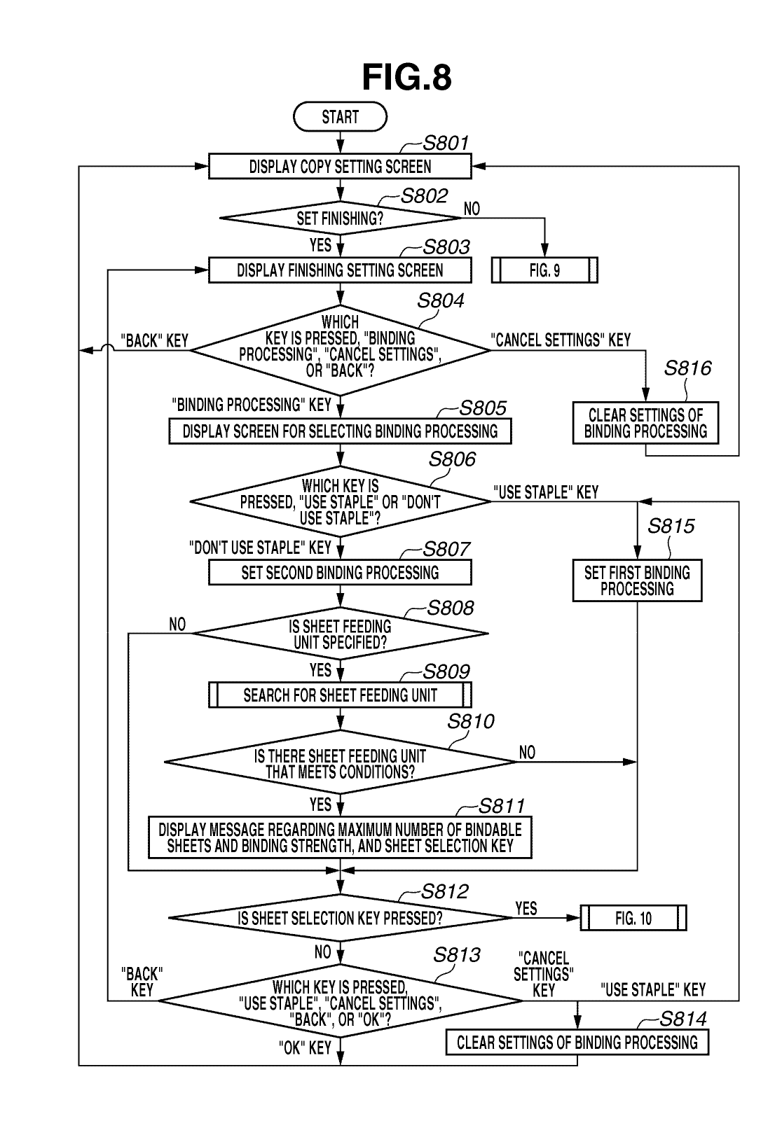

FIGS. 8, 9, 10, and 16 are flowcharts illustrating a control method for controlling execution of copying. The CPU 101 executes the control program based on the flowcharts, by which this control method is realized.

When the user selects COPY on a main screen displayed on the operation unit 105, the CPU 101 executes this control program. First, in step S801, the CPU 101 controls the operation unit 105 to display a user interface screen that allows the user to select copy settings.

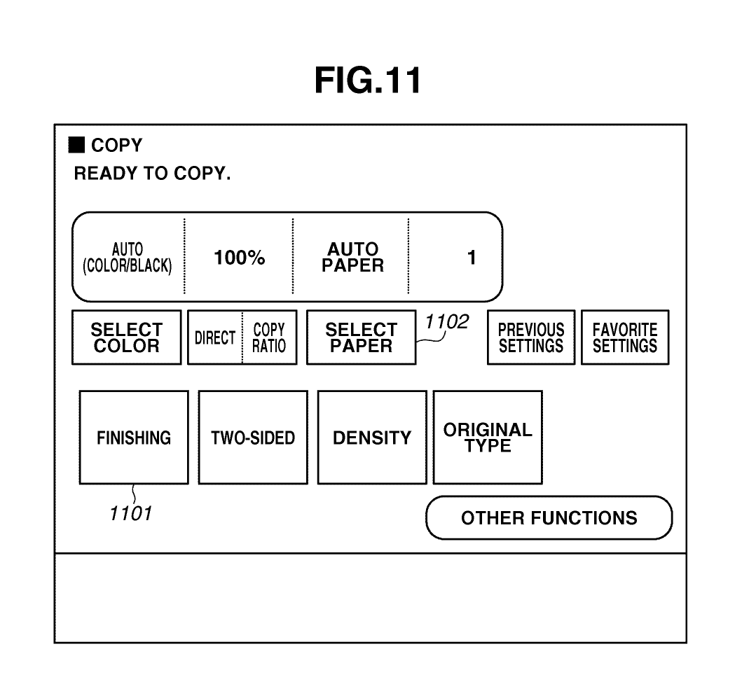

FIG. 11 illustrates an example of the user interface screen displayed in step S801. On the screen illustrated in FIG. 11, the user can, for example, select color copying or monochromatic copying, set a copy ratio, and select a type of two-sided copying. If the user wants to set finishing, the user presses a key 1101. If the user wants to select a sheet to be used for printing, the user presses a key 1102.

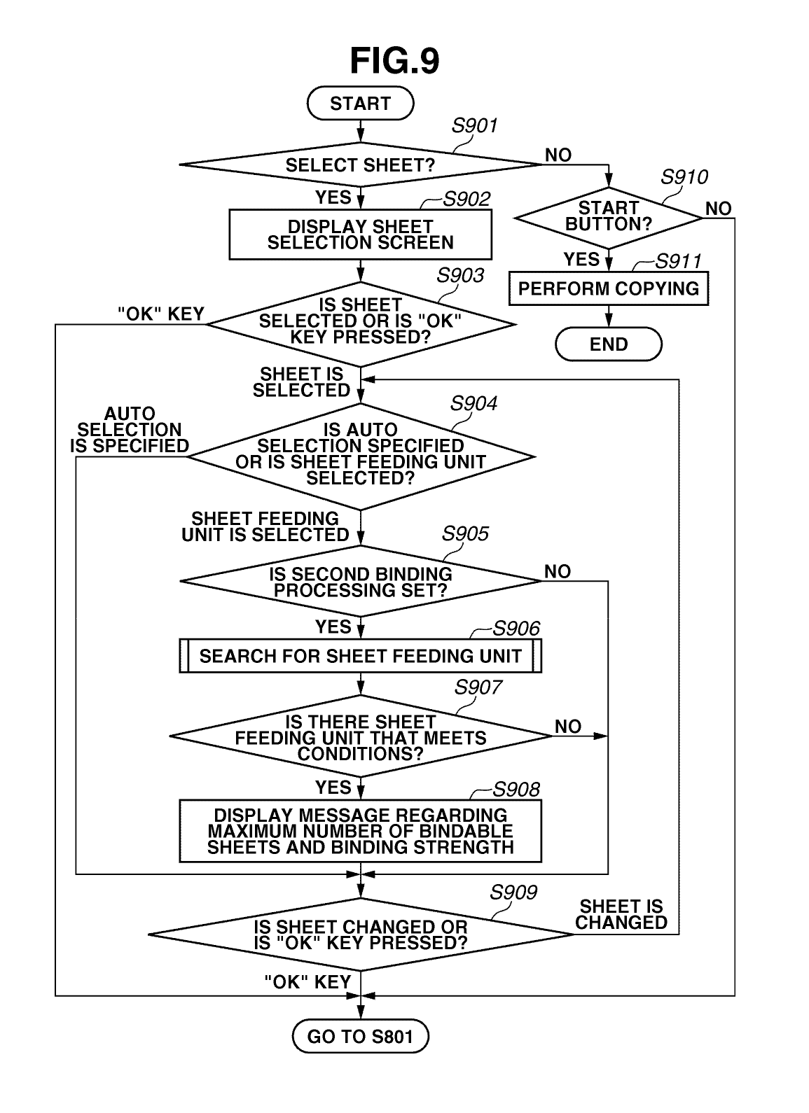

In step S802, the CPU 101 determines whether the key 1101 is pressed on the screen illustrated in FIG. 11. If the key 1101 is not pressed (NO in step S802), the CPU 101 advances the processing to the flowchart illustrated in FIG. 9.

If the key 1101 is pressed (YES in step S802), in step S803, the CPU 101 controls the operation unit 105 to display the user interface screen illustrated in FIG. 6. In step S804, the CPU 101 determines which key is pressed among keys 601 to 603 on the screen illustrated in FIG. 6. A key 604 is a key for setting a position to be bound. Further, keys 605 and 606 are keys for selecting finishing processing other than the binding processing. Control flows when the keys 604 to 606 are pressed are omitted from the flowchart illustrated in FIG. 8.

If the key 603 is pressed (“BACK” KEY in step S804), the CPU 101 returns the processing to step S801. If the key 602 is pressed (“CANCEL SETTINGS” KEY in step S804), in step S816, the CPU 101 clears setting values regarding the binding processing, and then returns the processing to step S801.

If the key 601 is pressed (“BINDING PROCESSING” KEY in step S804), in step S805, the CPU 101 controls the operation unit 105 to display the user interface screen illustrated in FIG. 7. In step S806, the CPU 101 determines whether the key 701 is pressed or the key 702 is pressed on the screen illustrated in FIG. 7.

If the key 701 is pressed on the screen illustrated in FIG. 7 so that the first binding unit using staples is selected (“USE STAPLE” KEY in step S806), in step S815, the CPU 101 sets use of the first binding processing. If the first binding processing is selected, a message that will be described below is not especially displayed.

If the key 702 is pressed on the screen illustrated in FIG. 7 so that the second binding unit using no staple is selected (“DON'T USE STAPLE” KEY in step S806), in step S807, the CPU 101 sets use of the second binding processing. Further, in step S808, the CPU 101 determines whether any sheet feeding unit is specified.

If the CPU 101 determines in step S808 that a sheet feeding unit is specified (YES in step S808), in step S809, the CPU 101 searches for a sheet feeding unit that stores sheets corresponding to a greater or equal maximum number of bindable sheets and a greater or equal binding strength compared to sheets stored in the specified sheet feeding unit. A method for searching for a sheet feeding unit in step S809 will be described below.

The maximum number of bindable sheets means a maximum number of sheets that are bindable. The binding strength means a strength with which a plurality of sheets is bound, i.e., how inseparable a plurality of bound sheets is.

In step S810, the CPU 101 determines whether any sheet feeding unit is found out by the search in step S809. If no sheet feeding unit is found out (NO in step S810), the CPU 101 advances the processing to step S812.

If a sheet feeding unit is found out (YES in step S810), in step S811, the CPU 101 controls the operation unit 105 to display a message regarding the maximum number of bindable sheets and the binding strength corresponding to each of the specified sheet feeding unit and the sheet feeding unit found out by the search in step S809, and a sheet selection key.

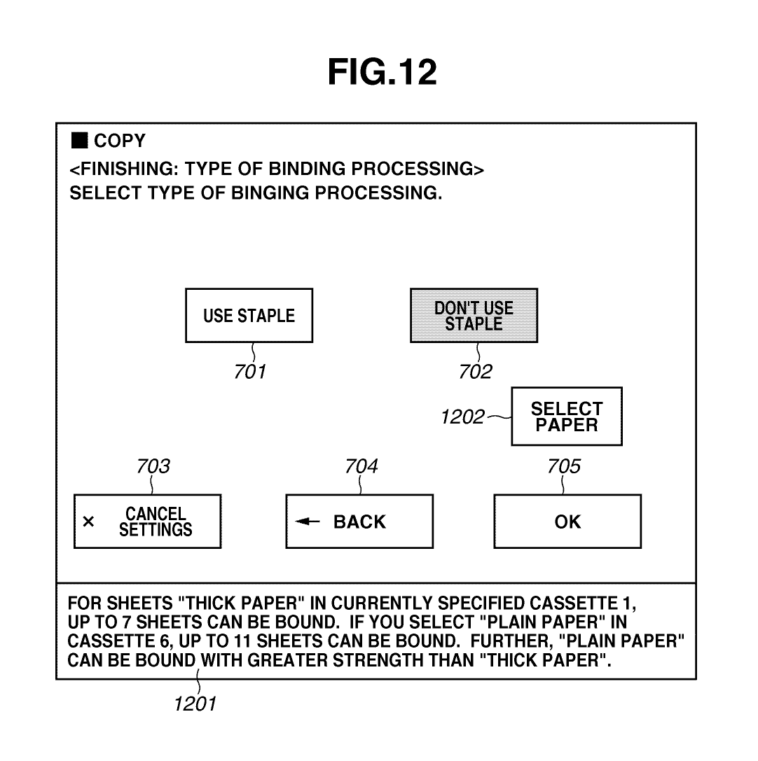

FIG. 12 illustrates an example of a user interface screen illustrated in step S811. A message 1201, which relates to the maximum number of bindable sheets when the sheets stored in each of the currently specified sheet feeding unit and the sheet feeding unit found out by the search in step S809 are bound by the second binding processing, is displayed at the bottom of the screen illustrated in FIG. 12. Further, the message 1201, which relates to the binding strength for the sheets stored in the currently specified sheet feeding unit and the binding strength for the sheets stored in the sheet feeding unit found out by the search in step S809, is displayed at the bottom of the screen illustrated in FIG. 12.

The user can determine whether the binding processing using no staple is sufficient to bind the sheets stored in the currently specified sheet feeding unit by reading the message regarding the maximum number of bindable sheets and the binding strength. Further, if the user determines that the binding processing using no staple is insufficient, the user can change the sheets (change the sheet feeding unit) by pressing the sheet selection (“SELECT PAPER”) key 1202.

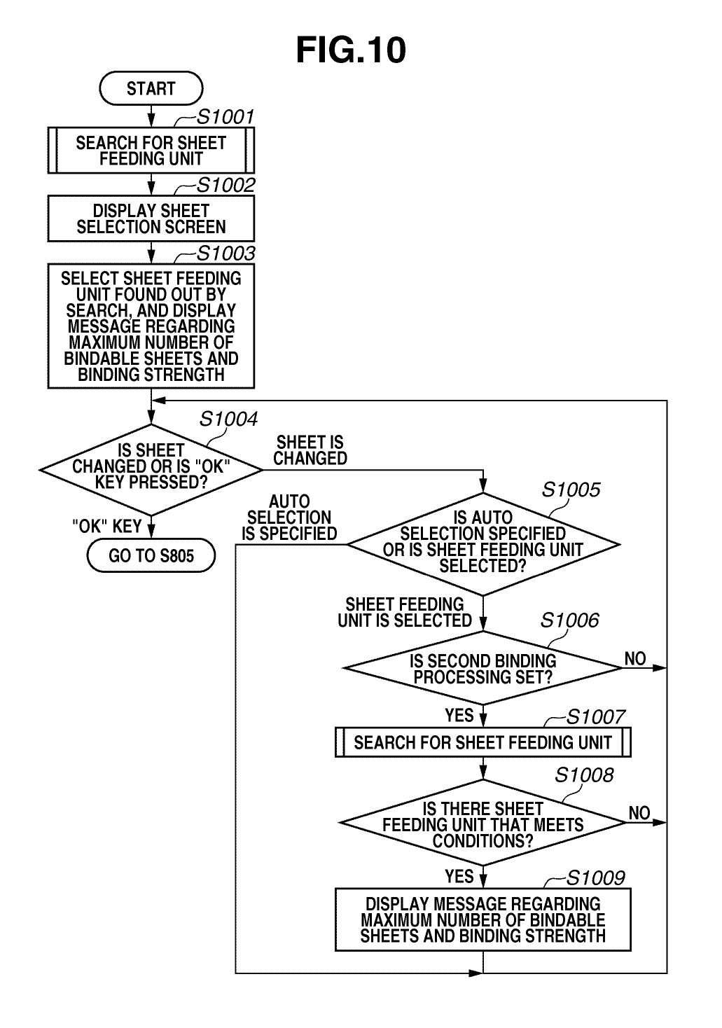

In step S812, the CPU 101 determines whether the sheet selection key 1202 is pressed. If the CPU 101 determines that the sheet selection key 1202 is pressed (YES in step S812), the CPU 101 advances the processing to the flowchart illustrated in FIG. 10. If the CPU 101 determines that the sheet selection key 1202 is not pressed (NO in step S812), in step S813, the CPU 101 determines which key is pressed among keys 701 and 703 to 705 on the screen illustrated in FIG. 12.

If the CPU 101 determines that the “USE STAPLE” key 701 is pressed (“USE STAPLE” KEY in step S813), the CPU 101 advances the processing to step S815.

If the CPU 101 determines that the “BACK” key 704 is pressed (“BACK” KEY in step S813), the CPU 101 returns the processing to step S803. If the CPU 101 determines that the “OK” key 705 is pressed (“OK” KEY in step S813), the CPU 101 returns the processing to step S801 while saving contents set or selected by the user into the SRAM 103 as setting values. If the CPU 101 determines that the “CANCEL SETTINGS” key 703 is pressed (“CANCEL SETTINGS” KEY in step S813), in step S814, the CPU 101 clears setting values regarding the binding processing, and then returns the processing to step S801.

The flowchart illustrated in FIG. 9 will be described now.

If the CPU 101 determines that the key 1101 is not pressed on the screen illustrated in FIG. 11, the CPU 101 performs control processing based on the flowchart illustrated in FIG. 9. In step S901, the CPU 101 determines whether the key 1102 is pressed on the screen illustrated in FIG. 11. If the CPU 101 determines that the key 1102 is pressed (YES in step S901), in step S902, the CPU 101 controls the operation unit 105 to display a user interface screen that allows the user to select a sheet to be used for printing.

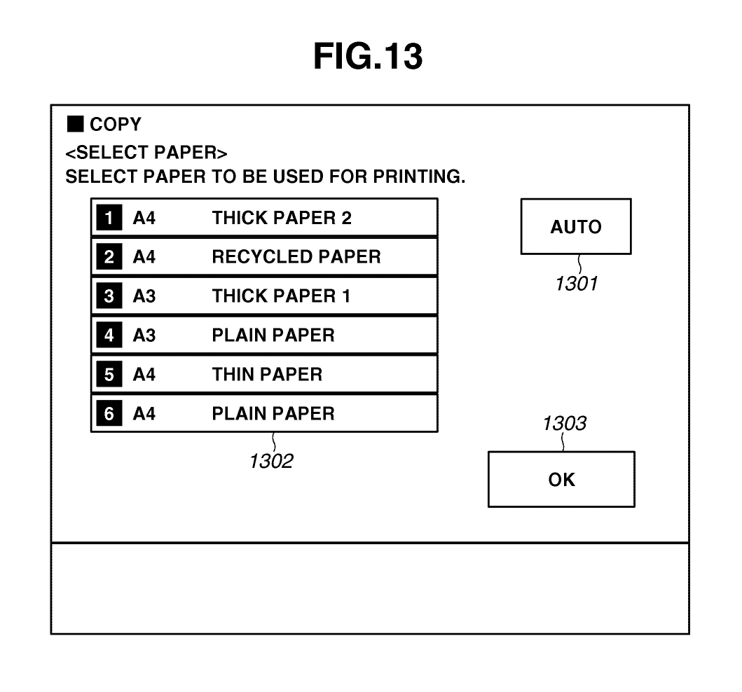

FIG. 13 illustrates an example of the user interface screen displayed in step S902. The user selects a sheet to be used for printing by selecting at least one of a plurality of sheet feeding units on the screen illustrated in FIG. 13. If an “AUTO” key 1301 is pressed by the user, the CPU 101 automatically selects a sheet to be used for printing based on the size of a document, and the like. In step S903, the CPU 101 determines whether any sheet is selected on the screen illustrated in FIG. 13, or an OK key 1303 is pressed. If a sheet is selected by the user (SHEET IS SELECTED in step S903), in step S904, the CPU 101 determines whether the “AUTO” key 1301 is pressed or a feed feeding unit selection key 1302 is pressed.

If the OK key 1303 is pressed by the user (“OK” KEY in step S903), the CPU 101 returns the processing to step S801 while saving the content set by the user regarding the sheet selection into the SRAM 103 as a setting value. If the “AUTO” key 1301 is pressed by the user (AUTO SELECTION IS SPECIFIED in step S904), the CPU 101 advances the processing to step S909. If the feet feeding unit selection key 1302 is pressed by the user (SHEET FEEDING UNIT IS SELECTED in step S904), in step S905, the CPU 101 determines whether the second binding processing using no staple is set.

If the CPU 101 determines in step S905 that the second binding processing is not set (NO in step S905), the CPU 101 advances the processing to step S909. If the CPU 101 determines in step S905 that the second binding processing is set (YES in step S905), in step S906, the CPU 101 searches for a sheet feeding unit that stores sheets corresponding to a greater or equal maximum number of bindable sheets and a greater or equal binding strength compared to sheets stored in the specified sheet feeding unit. A method for searing for a sheet feeding unit in step S906 will be described below.

In step S907, the CPU 101 determines whether any sheet feeding unit is found out by the search in step S906. If no sheet feeding unit is found out (NO in step S907), the CPU 101 advances the processing to step S909.

If a sheet feeding unit is found out (YES in step S907), in step S908, the CPU 101 controls the operation unit 105 to display a message regarding the maximum number of bindable sheets and the binding strength corresponding to each of the specified sheet feeding unit and the sheet feeding unit found out by the search in step S906.

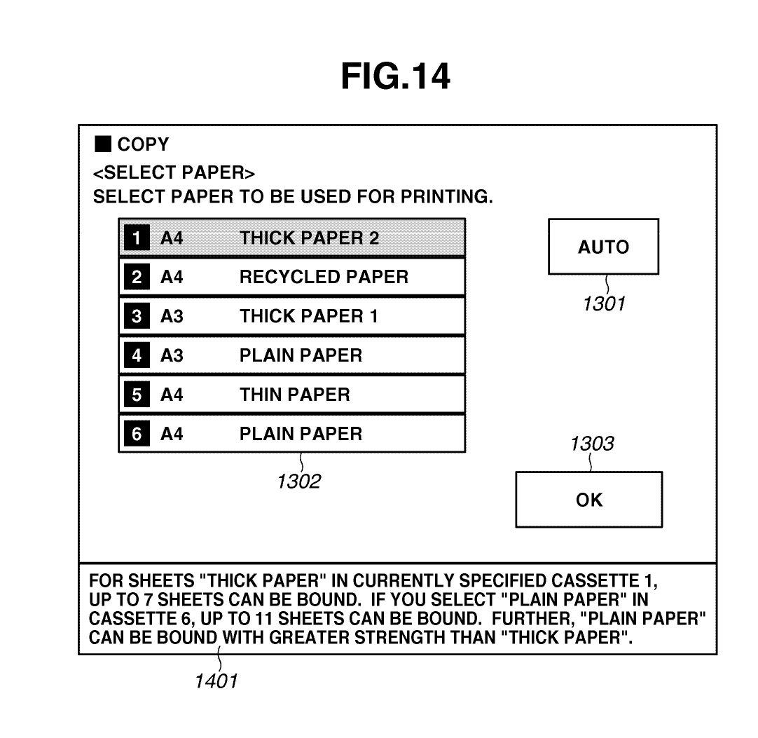

FIG. 14 illustrates an example of a user interface screen displayed in step S908. If a cassette 1 is selected by the user, the maximum number of bindable sheets corresponding to sheets stored in the cassette 1 is displayed at the bottom of the screen illustrated in FIG. 14. Further, a message regarding a cassette 6, which stores sheets corresponding to a greater maximum number of bindable sheets and a greater binding strength, is displayed at the bottom of the screen illustrated in FIG. 14.

The user can confirm the maximum number of bindable sheets when the sheets stored in the currently specified sheet feeding unit are bound without use of staples, by viewing the message illustrated in FIG. 14. Further, the user can also confirm which another sheet type has the same size and corresponds to a greater or equal maximum number of bindable sheets and a greater or equal binding strength. If the user determines that the sheets stored in the specified sheet feeding unit are insufficient, the user can change the sheets. If the user wants to change the sheets, the user presses the “AUTO” key 1301 or the sheet feeding unit selection key 1302.

In step S909, the CPU 101 determines whether the sheet is changed or the OK key 1303 is pressed on the screen illustrated in FIG. 13 or 14. If the CPU 101 determines that the sheet is changed (SHEET IS CHANGED in step S909), the CPU 101 returns the processing to step S904. If the CPU determines that the OK key 1303 is pressed by the user (“OK” KEY in step S909), the CPU 101 returns the processing to step S801 while saving the content set by the user regarding the sheet selection into the SRAM 103 as a setting value.

If the key 1102 is not pressed on the screen illustrated in FIG. 11 (NO in step S901), in step S910, the CPU 101 determines whether the start button (not illustrated) is pressed. The start button is provided on the operation unit 105. If the start button is pressed (YES in step S910), in step S911, the CPU 101 controls the reading unit 106 and/or the printing unit 107 according to the setting values saved in the SRAM 103 to carry out copying. If the start button is not pressed (NO in step S910), the CPU 101 returns the processing to step S801.

Other settings can be also selected on the screen illustrated in FIG. 11, but descriptions of the other settings are omitted herein.

The flowchart illustrated in FIG. 10 will be described now.

If the CPU 101 determines in step S812 that the sheet selection key 1202 is pressed, the CPU 101 performs control processing based on the flowchart illustrated in FIG. 10. First, in step S1001, the CPU 101 searches for a sheet feeding unit that stores sheets corresponding to a greater or equal maximum number of bindable sheets and a greater or equal binding strength compared to the sheets stored in the currently specified sheet feeding unit.

In step S1002, the CPU 101 controls the operation unit 105 to display the user interface screen that allows the user to select sheets to be used for printing. Further, in step S1003, the CPU 101 changes the sheet selection from a state in which the currently specified sheet feeding unit is selected to a state in which the sheet feeding unit found out by the search in step S1001 is selected. Then, the CPU 101 controls the operation unit 105 to display a message regarding the maximum number of bindable sheets and the binding strength corresponding to each of the sheet feeding unit before the change and the sheet feeding unit after the change.

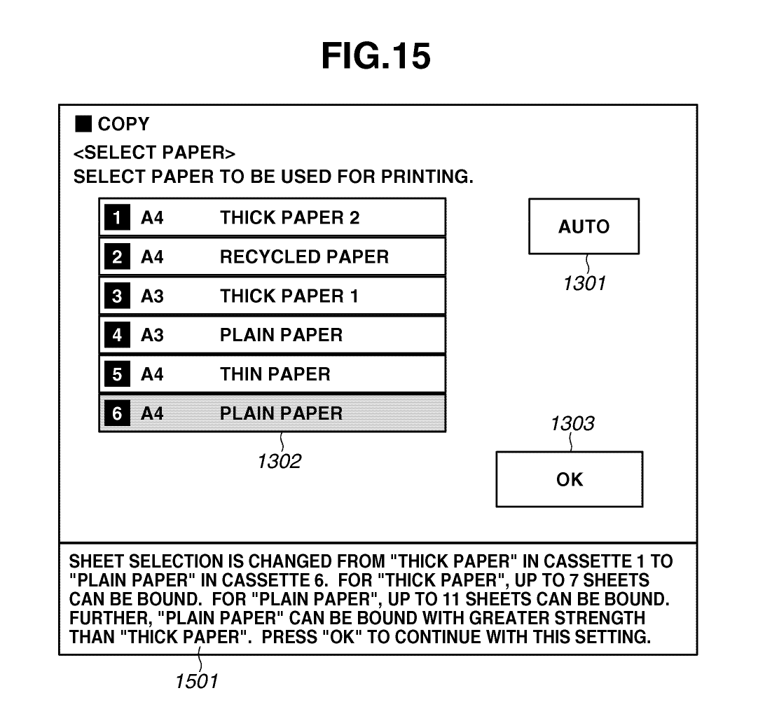

FIG. 15 illustrates an example of the user interface screen displayed in step S1002 and step S1003. A message 1501, which relates to the sheet feeding unit before the change (the cassette 1) and the sheet feeding unit after the change (the cassette 6), is displayed at the bottom of the screen illustrated in FIG. 15.

If the user determines that the currently specified sheets are insufficient by viewing the screen illustrated in FIG. 12, the user presses the sheet selection key 1202. Because the sheet feeding unit that stores sheets corresponding to a greater maximum number of bindable sheets and a greater binding strength is automatically selected on the screen illustrated in FIG. 15, the user can complete the setting only by pressing the OK key 1303. Further, the user can further change the sheet feeding unit from the sheet feeding unit selected on the screen illustrated in FIG. 15.

In step S1004, the CPU 101 determines whether the sheets are changed or the OK key 1303 is pressed on the screen illustrated in FIG. 15. If the CPU 101 determines in step S1004 that the OK key 1303 is pressed (“OK” KEY in step S1004), the CPU 101 returns the processing to step S805 while saving the content set by the user regarding the sheet selection into the SRAM 103 as a setting value.

If the CPU 101 determines in step S1004 that the sheets are changed (SHEETS ARE CHANGED in step S1004), in step S1005, the CPU 101 determines whether the “AUTO” key 1301 is pressed or the sheet feeding unit selection key 1302 is pressed. If the CPU 101 determines in step S1005 that the “AUTO” key 1301 is pressed (AUTO SELECTION IS SPECIFIED in step S1005), the CPU 101 returns the processing to step S1004. If the CPU 101 determines in step S1005 that the sheet feeding unit selection key 1302 is pressed (SHEET FEEDING UNIT IS SELECTED in step S1005), in step S1006, the CPU 101 determines whether the second binding processing is set. If the CPU 101 determines in step S1006 that the second binding processing is not set (NO in step S1006), the CPU 101 returns the processing to step S1004.

If the CPU 101 determines in step S1006 that the second binding processing is set (YES in step S1006), in step S1007, the CPU 101 searches for a sheet feeding unit that stores sheets corresponding to a greater or equal maximum number of bindable sheets and a greater or equal binding strength compared to the sheets stored in the specified sheet feeding unit.

In step S1008, the CPU 101 determines whether any sheet feeding unit is found out by the search in step S1007. If no sheet feeding unit is found out (NO in step S1008), the CPU 101 returns the processing to step S1004.

If a sheet feeding unit is found out (YES in step S1008), in step S1009, the CPU 101 controls the operation unit 105 to display a message regarding the maximum number of bindable sheets and the binding strength corresponding to the sheets stored in each of the specified sheet feeding unit and the sheet feeding unit found out by the search.

The user can determine whether the specified sheet feeding unit allows the binding processing to succeed by confirming the message displayed in step S1009. If the user determines that the binding processing is impossible with the currently specified sheet feeding unit, the user can newly specify a sheet feeding unit that stores sheets corresponding to a greater maximum number of bindable sheets and a greater binding strength.

The method for searching for a sheet feeding unit that is performed in steps S809, S906, S1001, and S1007 will be described now. According to the present exemplary embodiment, the CPU 101 searches for a sheet feeding unit that stores sheets corresponding to a greater or equal maximum number of bindable sheets and a greater or equal binding strength compared to sheets stored in a specified sheet feeding unit. However, the CPU 101 may search for a sheet feeding unit that stores sheets corresponding to a greater maximum number of bindable sheets and a greater binding strength compared to sheets stored in a specified sheet feeding unit.

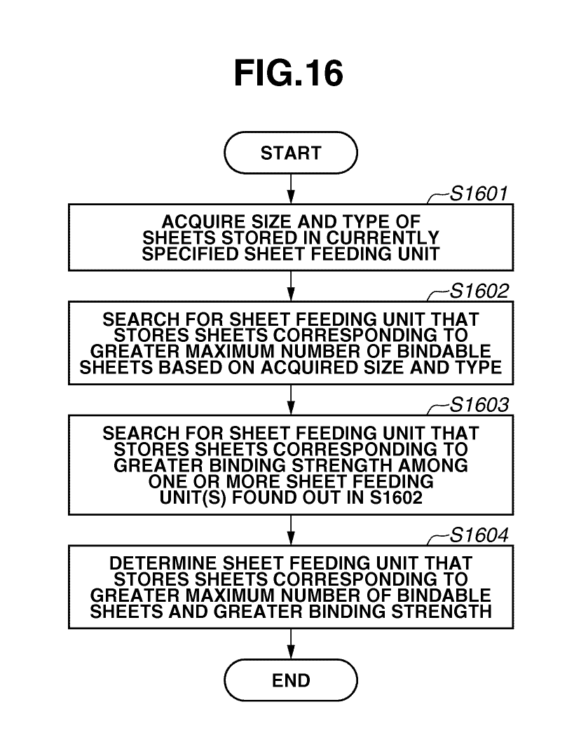

FIG. 16 is a flowchart illustrating the method for searching for a sheet feeding unit.

In step S1601, the CPU 101 acquires the size and the type of sheets stored in the specified sheet feeding unit. Information regarding the size and the type of sheets stored in each sheet feeding unit is stored in the SRAM 103.

The CPU 101 selects a sheet feeding unit based on the size and the type acquired in step S1601. More specifically, in step S1602, the CPU 101 selects a sheet feeding unit that stores sheets corresponding to a greater or equal maximum number of bindable sheets compared to the sheets of the acquired type among sheet feeding units that store sheets having a same size as the acquired size.

Further, in step S1603, the CPU 101 selects one or more sheet feeding unit(s) that store(s) sheets corresponding to a greater or equal binding strength compared to the sheets of the type acquired in step S1601, among one or more sheet feeding unit(s) selected in step S1602. Further, the CPU 101 selects a sheet feeding unit that stores sheets corresponding to a strongest binding strength among them.

If a plurality of sheet feeding units meets the conditions, one of them is selected. In step S1604, the CPU 101 determines that the sheet feeding unit selected in step S1603 is a sheet feeding unit that stores sheets corresponding to a greater or equal maximum number of bindable sheets and a greater or equal binding strength compared to the sheets stored in the specified sheet feeding unit.

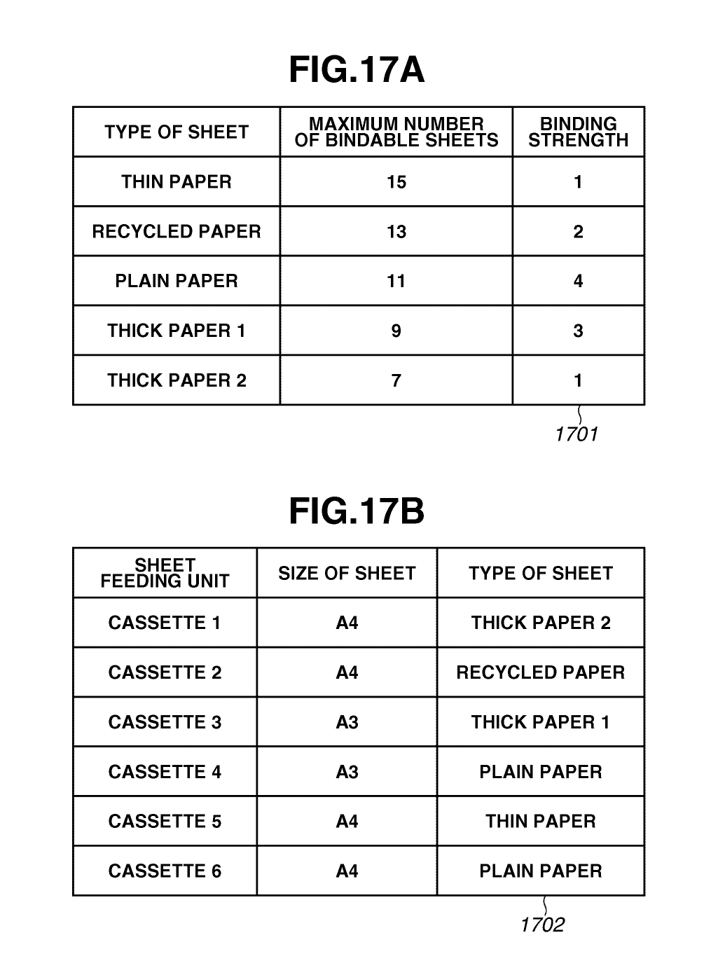

FIGS. 17A and 17B illustrate two tables used in the method for searching for a sheet feeding unit.

A table 1701 is a table that indicates a maximum number of sheets that are bindable by the second binding processing and a strength when sheets are bound by the second binding processing for each sheet type. The table 1701 is stored in the SRAM 103. The maximum number of bindable sheets indicated in the table 1701 may be fixed, or may be able to be changed by the user.

If sheets are bound by the second binding processing, for example, bound thick paper sheets are more easily separated from one another than bound plain paper sheets, because the thick paper is thicker than the plain paper. The binding strength for each type is determined based on a grammage of sheets, a surface property of sheets, and the like. The binding strength indicated in the table 1701 may be fixed, or may be able to be changed by the user. As the binding strength has a greater number, this means that sheets are more inseparable from one another.

A table 1702 is a table that indicates a size and a type of sheets stored in a sheet feeding unit for each sheet feeding unit. The table 1702 is also stored in the SRAM 103. When the user sets sheets in a certain sheet feeding unit, the user inputs the sheet feeding unit, the size of the sheets, and the type of the sheets via the operation unit 105. The size and type input via the operation unit 105 are registered with the table 1702. If each sheet feeding unit has a sheet detection unit configured to detect a size of sheets and a type of sheets, the size and the type detected by the sheet detection unit are registered with the table 1702.

The CPU 101 determines a maximum number of bindable sheets and a binding strength for sheets stored in each sheet feeding unit by reading out the tables 1701 and 1702 from the SRAM 103 and referring thereto.

For example, suppose that a specified sheet feeding unit is the cassette 1. First, the CPU 101 refers to the tables 1701 and 1702 to acquire the size, the maximum number of bindable sheets, and the binding strength for sheets stored in the cassette 1. Next, the CPU 101 refers to the table 1702 to select cassettes 2, 5, and 6 as sheet feeding units that store sheets of a same size as “A4”, which is the size of the sheets stored in the cassette 1. Further, the CPU 101 refers to the table 1701 to acquire the maximum numbers of bindable sheets corresponding to sheets stored in the cassettes 2, 5, and 6. Then, the CPU 101 compares the maximum numbers of bindable sheets corresponding to the sheets stored in the respective cassettes 1, 2, 5, and 6. All of the maximum numbers of bindable sheets for the sheets stored in the respective cassettes 2, 5, and 6 are greater than or equal to the maximum number of bindable sheets for the sheets stored in the cassette 1. Therefore, the CPU 101 refers to the table 1701 to acquire the binding strengths corresponding to the types of the sheets stored in the respective cassettes 2, 5, and 6. Because all of the binding strengths corresponding to the respective recycled paper, thin paper, and plain paper are greater than or equal to the binding strength for thick paper 2, the CPU 101 selects the plain paper corresponding to a largest binding strength among the recycled paper, the thin paper, and the plain paper. In this example, the CPU 101 selects the cassette 6 as a sheet feeding unit that stores sheets corresponding to a greater or equal maximum number of bindable sheets and a greater or equal binding strength compared to the sheets stored in the cassette 1. Further, if there is a plurality of sheet feeding units that stores sheets of a same size and a same type, the CPU 101 selects one of them.

According to the first exemplary embodiment, the user can confirm whether the maximum number of bindable sheets is sufficient when the currently specified sheets are bound without use of staples. Further, the user can also confirm that there is another sheet type corresponding to a greater maximum number of bindable sheets and a greater binding strength.

According to the above-described first exemplary embodiment, the image processing apparatus searches for a sheet feeding unit based on two attributes, i.e., the maximum number of bindable sheets and the binding strength, and displays the message regarding the maximum number of bindable sheets and the binding strength. However, the image processing apparatus may search for a sheet feeding unit based on any one of the attributes, and display a message regarding only the one of the maximum number of bindable sheets and the binding strength.

According to the above-described first exemplary embodiment, the image processing apparatus performs copying in step S911 illustrated in FIG. 9. However, the image processing apparatus may include a hard disk, and perform printing based on print data stored in the hard disk in step S911. In this case, the communication unit 108 receives print data from an external apparatus, and the CPU 101 stores that print data into the hard disk. In step S911, the CPU 101 controls the printing unit 107 according to the setting values saved in the SRAM 103, and controls the printing unit 107 to print the print data stored in the HDD.

According to the above-described first exemplary embodiment, the image processing apparatus includes the CPU 101, the reading unit 106, the printing unit 107, the sheet processing unit 109, and the like. However, an exemplary embodiment of the present invention may be such an embodiment that a printing control apparatus, which controls the printing unit 107 and the sheet processing unit 109, includes the CPU 101, the ROM 102, the SRAM 103, the DRAM 104, the operation unit 105, and the communication unit 108.

The first exemplary embodiment has been described as the exemplary embodiment based on the image processing apparatus or the printing control apparatus. However, the present invention can be applied even to an information processing apparatus that transmits print data to an image processing apparatus.

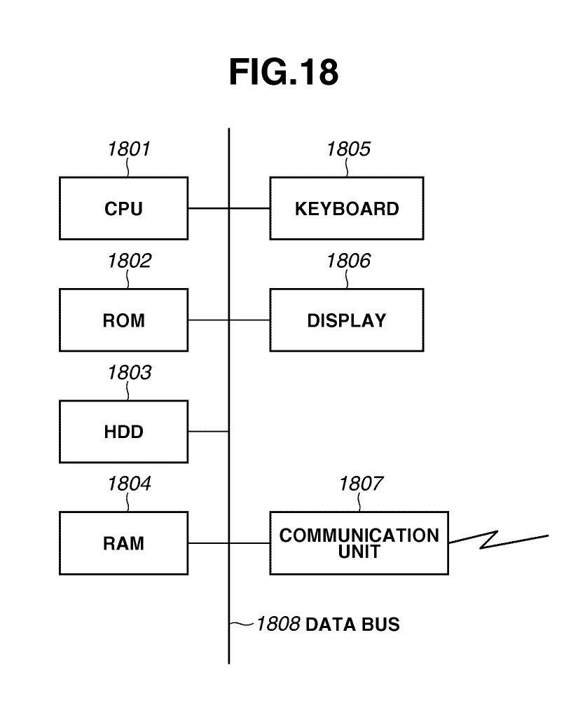

FIG. 18 is a block diagram illustrating a configuration of an information processing apparatus according to a second exemplary embodiment. The information processing apparatus has a function of transmitting print data to an image processing apparatus, and causing the image processing apparatus to perform printing based on the print data.

A CPU 1801 is a control unit of the information processing apparatus. The CPU 1801 controls the whole information processing apparatus by executing a program. A ROM 1802 stores the control program that the CPU 1801 can execute. An HDD 1803 stores setting values registered by a user, management data of the information processing apparatus, an application program such as a document application and a calculation application, a driver application for transmitting print data to the image processing apparatus, and the like. A RAM 1804 stores control variables of the program that is executed by the CPU 1801. Further, the RAM 1804 also functions as a buffer for work of the CPU 1801.

A keyboard 1805 is used to input an instruction from the user, and input a character, a number, and the like. A mouse may be prepared in addition to the keyboard 1805. A display 1806 displays information to the user. The user presses a key displayed on the display 1806 using the keyboard 1805 and the mouse. The display 1806 displays various kinds of information to notify the user of these kinds of information. If the information processing apparatus includes a speaker, the speaker may notify the user of these kinds of information with a sound.

A communication unit 1807 communicates with an external apparatus. The communication unit 1807 transmits print data to the image processing apparatus, and receives image data from the image processing apparatus. The communication unit 1807 communicates with an external apparatus via a network such as a wired LAN or a wireless LAN, and communicates with an external apparatus via a local interface such as a USB. A data bus 1808 transfers data and a control signal among the various kinds of devices.

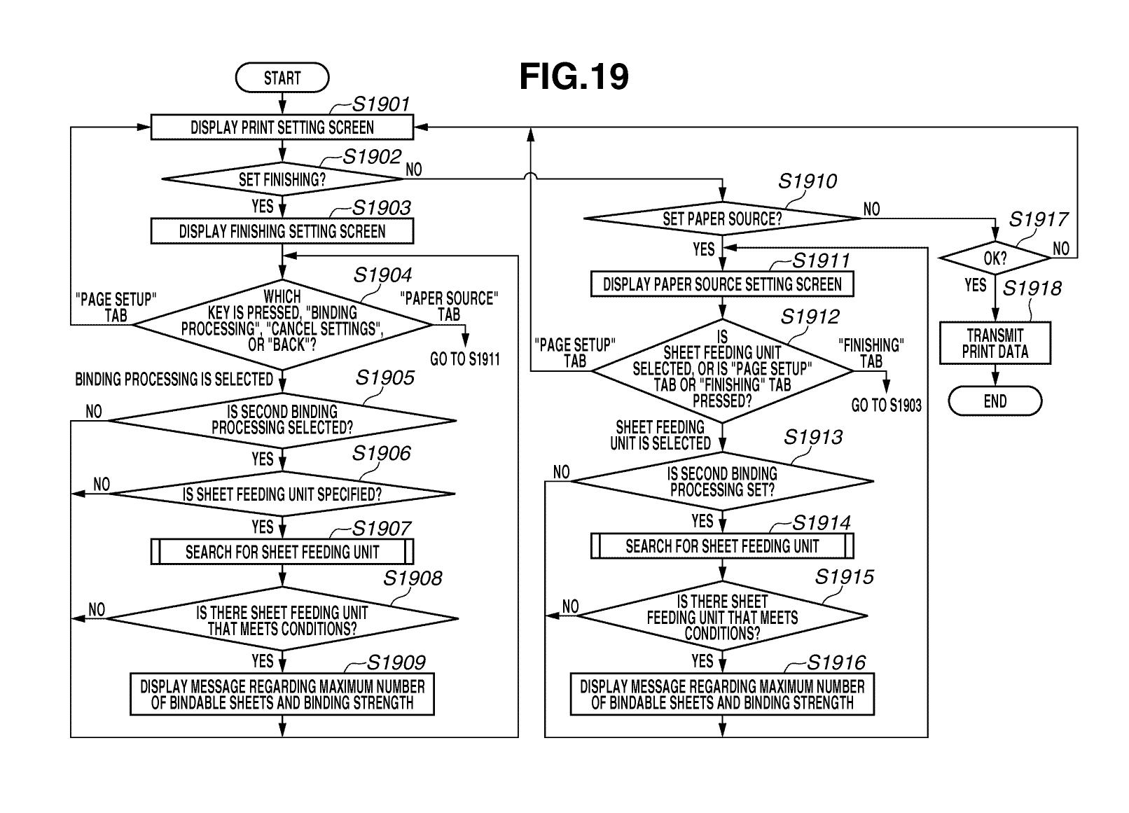

FIG. 19 is a flowchart illustrating a control method for transmitting print data to the image processing apparatus. The CPU 1801 executes the driver program based on this flowchart, by which this control method is realized.

Upon the user's issuing an instruction to print data, the CPU 1801 executes the driver program. In step S1901, the CPU 1801 controls the display 1806 to display a user interface screen that allows the user to set printing.

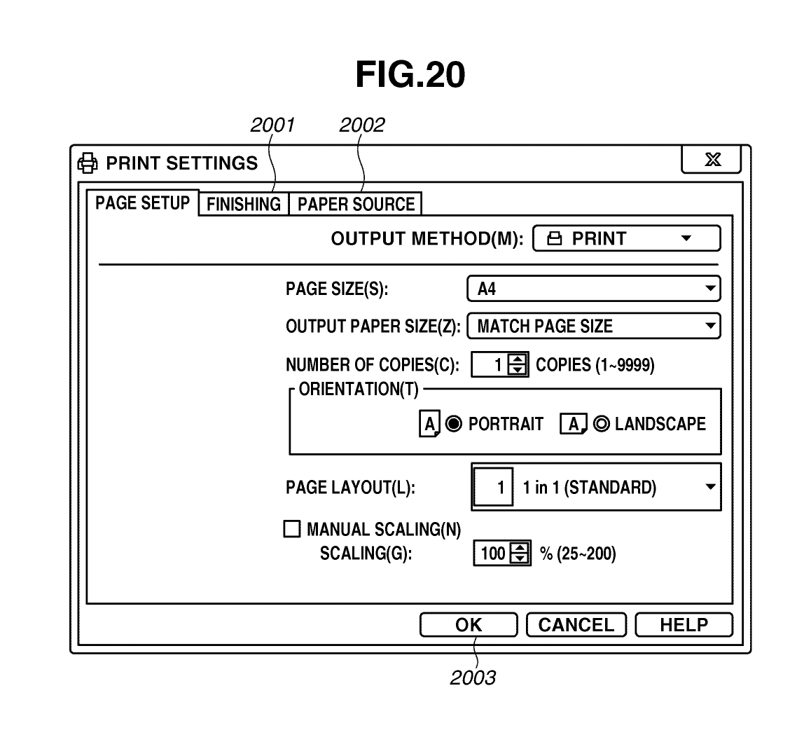

FIG. 20 illustrates an example of the user interface screen displayed in step S1901. The user can set a document size (page size), a size of a sheet to be printed (output page size), the number of copies, an orientation of printing, a page layout (N in 1), and the like on the screen illustrated in FIG. 20. If the user wants to set finishing, the user presses a tab key 2001. If the user wants to specify a sheet feeding unit, the user presses a tab key 2002. If the user wants to transmit print data to the image processing apparatus, the user presses an OK key 2003.

In step S1902, the CPU 1801 determines whether the tab key 2001 is pressed on the screen illustrated in FIG. 20. If the tab key 2001 is pressed (YES in step S1902), in step S1903, the CPU 1801 controls the display 1806 to display a user interfaces screen that allows the user to set finishing.

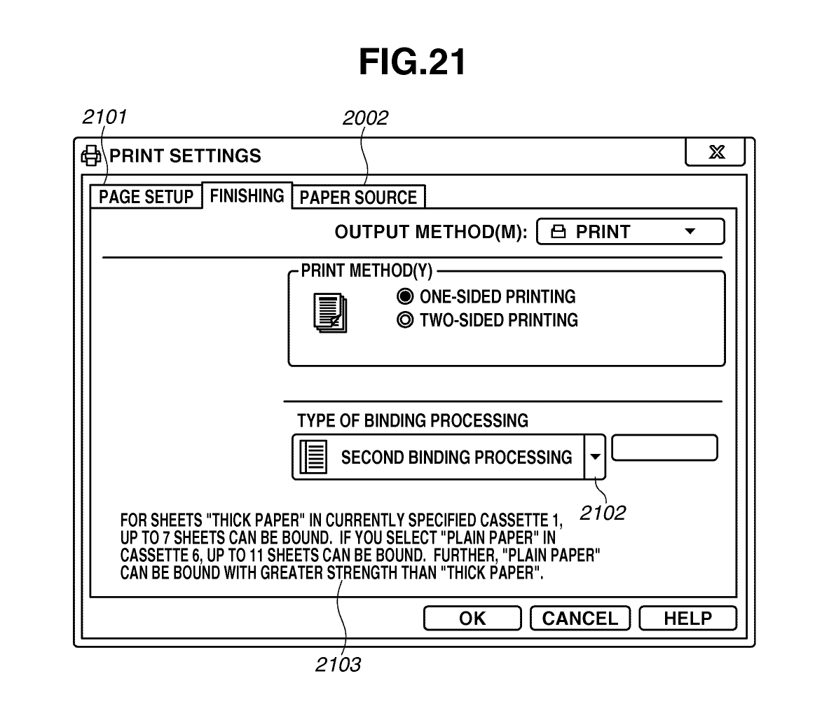

FIG. 21 illustrates an example of the user interface screen displayed in step S1903. A message 2103 is not displayed yet in step S1903. The user can select one-sided printing or two-sided printing, and a type of the binding processing on the screen illustrated in FIG. 21. If the user wants to return to the screen illustrated in FIG. 20, the user presses a tab key 2101. If the user wants to select a type of the binding processing, the user presses a selection key 2102.

In step S1904, the CPU 1801 determines which key is pressed among the keys 2002, 2101, and 2102 on the screen illustrated in FIG. 21.

If the key 2002 is pressed on the screen illustrated in FIG. 21 (“PAPER SOURCE” TAB in step S1904), the CPU 1801 advances the processing to step S1911. If the key 2101 is pressed on the screen illustrated in FIG. 21 (“PAGE SETUP” TAB in step S1904), the CPU 1801 returns the processing to step S1901.

If the key 2102 is pressed on the screen illustrated in FIG. 21 (BINDING PROCESSING IS SELECTED in step S1904), the CPU 1801 saves a setting value indicating the binding processing selected by the user into the HDD 1803. Further, in step S1905, the CPU 1801 determines whether the second binding processing is selected. If the second binding processing is not selected (NO in step S1905), the CPU 1801 returns the processing to step S1904. If the second binding processing is selected (YES in step S1905), in step S1906, the CPU 1801 determines whether any sheet feeding unit is specified.

If the CPU 1801 determines in step S1906 that a sheet feeding unit is specified (YES in step S1906), in step S1907, the CPU 1801 searches for a sheet feeding unit that stores sheets corresponding to a greater or equal maximum number of bindable sheets and a greater or equal binding strength compared to sheets stored in the specified sheet feeding unit.

The CPU 1801 searches for a sheet feeding unit in step S1907 according to the method described with reference to FIG. 16. The CPU 1801 performs the search method based on the flowchart illustrated in FIG. 16. The CPU 1801 acquires the tables 1701 and 1702 illustrated in FIGS. 17A and 17B from the image processing apparatus via the communication unit 1807 to store the tables 1701 and 1702 into the HDD 1803, and then performs the search method illustrated in FIG. 16.

In step S1908, the CPU 1801 determines whether any sheet feeding unit is found out by the search in step S1907. If no sheet feeding unit is found out (NO in step S1908), the CPU 1801 returns the processing to step S1904.

If a sheet feeding unit is found out (YES in step S1908), in step S1909, the CPU 1801 controls the display 1806 to display a message regarding the maximum number of bindable sheets and the binding strength corresponding to each of the specified sheet feeding unit and the sheet feeding unit found out by the search in step S1907.

The message 2103 illustrated in FIG. 21 is an example of the message displayed in step S1909. The message 2103, which relates to the maximum number of bindable sheets when the sheets stored in each of the currently specified sheet feeding unit and the sheet feeding unit found out by the search in step S1907 are bound by the second binding processing, is displayed at the bottom of the screen illustrated in FIG. 21. Further, the message 2103, which relates to the binding strength for the sheets stored in the currently specified sheet feeding unit and the binding strength for the sheets stored in the sheet feeding unit found out by the search in step S1907, is displayed at the bottom of the screen illustrated in FIG. 21.

The user can determine whether the second binding processing is sufficient to bind the sheets stored in the currently specified sheet feeding unit by reading the message regarding the maximum number of bindable sheets and the binding strength. Further, if the user determines that the second binding processing is insufficient, the user can change the sheets (change the sheet feeding unit) by pressing the key 2002.

If the CPU 1801 determines in step S1902 that the tab key 2001 is not pressed on the screen illustrated in FIG. 20 (NO in step S1902), in step S1910, the CPU 1801 determines whether the tab key 2002 is pressed on the screen illustrated in FIG. 20. If the tab key 2002 is pressed (YES in step S1910), in step S1911, the CPU 1801 controls the display 1806 to display a user interface screen that allows the user to select a sheet feeding unit.

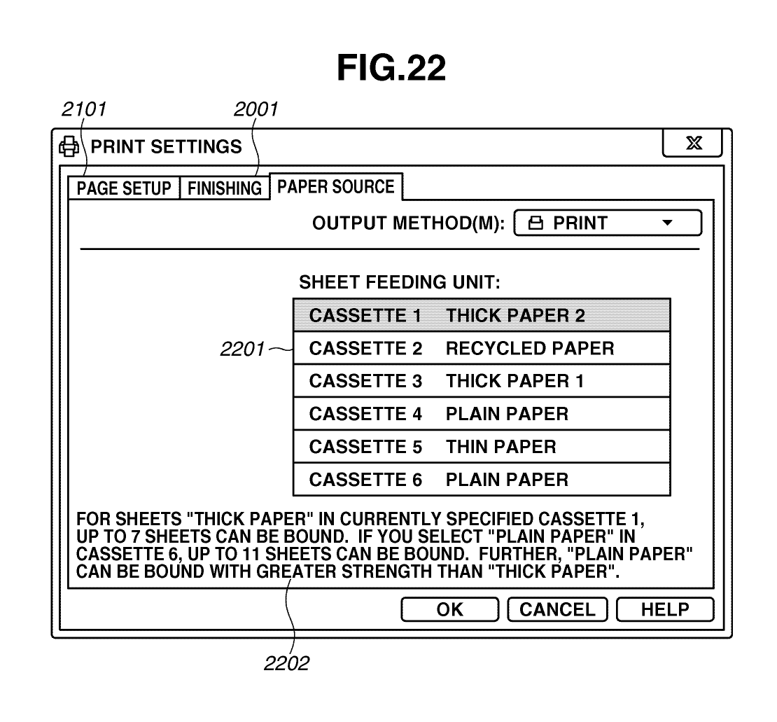

FIG. 22 illustrates an example of the user interface screen displayed in step S1911. A message 2202 is not displayed yet in step S1911. The user can select a sheet feeding unit on the screen illustrated in FIG. 22. If the user wants to return to the screen illustrated in FIG. 20, the user presses the tab key 2101. If the user wants to return to the screen illustrated in FIG. 21, the user presses the tab key 2001. If the user wants to select a sheet feeding unit, the user presses a selection key 2201.

In step S1912, the CPU 1801 determines which key is pressed among the keys 2001, 2101, and 2201 on the screen illustrated in FIG. 22.

If the key 2001 is pressed on the screen illustrated in FIG. 22 (“FINISHING” TAB in step S1912), the CPU 1801 advances the processing to step S1903. If the key 2101 is pressed on the screen illustrated in FIG. 22 (“PAGE SETUP” TAB in step S1912), the CPU 1801 returns the processing to step S1901.

If the key 2201 is pressed on the screen illustrated in FIG. 22 (SHEET FEEDING UNIT IS SELECTED in step S1912), the CPU 1801 saves a setting value indicating the sheet feeding unit selected by the user into the HDD 1803. Further, in step S1913, the CPU 1801 determines whether the second binding processing is set. If the CPU 1801 determines in step S1913 that the second binding processing is set (YES in step S1913), in step S1914, the CPU 1801 searches for a sheet feeding unit that stores sheets corresponding to a greater or equal maximum number of bindable sheets and a greater or equal binding strength compared to sheets stored in the specified sheet feeding unit. Step S1914 is similar to step S1907.

In step S1915, the CPU 1801 determines whether any sheet feeding unit is found out by the search in step S1914. If no sheet feeding unit is found out (NO in step S1915), the CPU 1801 returns the processing to step S1911.

If a sheet feeding unit is found out (YES in step S1915), in step S1916, the CPU 1801 controls the display 1806 to display a message regarding the maximum number of bindable sheets and the binding strength corresponding to each of the specified sheet feeding unit and the sheet feeding unit found out by the search in step S1914.

The message 2202 illustrated in FIG. 22 is an example of the message displayed in step S1916. The message 2202, which relates to the maximum number of bindable sheets when the sheets stored in each of the currently specified sheet feeding unit and the sheet feeding unit found out by the search in step S1914 are bound by the second binding processing, is displayed at the bottom of the screen illustrated in FIG. 22. Further, the message 2202, which relates to the binding strength for the sheets stored in the currently specified sheet feeding unit and the binding strength for the sheets stored in the sheet feeding unit found out by the search in step S1914, is displayed at the bottom of the screen illustrated in FIG. 22.

The user can determine whether the second binding processing is sufficient to bind the sheets stored in the currently specified sheet feeding unit by reading the message regarding the maximum number of bindable sheets and the binding strength. Further, if the user determines that the second binding processing is insufficient, the user can change the sheets (change the sheet feeding unit) by pressing the key 2201.

If the CPU 1801 determines in step S1910 that the tab key 2002 is not pressed on the screen illustrated in FIG. 20 (NO in step S1910), in step S1917, the CPU 1801 determines whether the OK key 2003 is pressed on the screen illustrated in FIG. 20.

If the OK key 2003 is pressed (YES in step S1917), in step S1918, the CPU 1801 generates print data according to the setting values saved in the HDD 1803. Further, in step S1918, the CPU 1801 controls the communication unit 1807 to transmit the print data to the image processing apparatus.

The image processing apparatus conveys the sheets from the sheet feeding unit specified in the print data, prints images based on the print data on the conveyed sheets, and then performs the binding processing specified in the print data.

If the OK key 2003 is not pressed (NO in step S1917), the CPU 1801 returns the processing to step S1901. Other keys are also displayed on the screens illustrated in FIGS. 20 to 22, but descriptions of the other keys are omitted herein.

According to the second exemplary embodiment, the user can confirm that there is another sheet type corresponding to a greater maximum number of bindable sheets and a greater binding strength, even when the information processing apparatus transmits print data to the image processing apparatus, and the image processing apparatus performs the binding processing based on the print data.

Further, the CPU 101 and the CPU 1801 may be replaced with a control circuit designed to perform the processing based on the respective flowcharts.

According to the exemplar embodiments of the present invention, the user can confirm that there is another sheet type corresponding to a greater or equal maximum number of bindable sheets and a greater or equal binding strength.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-011137 filed Jan. 24, 2013, which is hereby incorporated by reference herein in its entirety.

What is claimed is:

1. An image processing apparatus that prints an image on a sheet and controls a binding unit to bind a plurality of sheets, the image processing apparatus comprising:
a printing unit configured to print an image on a sheet;
a control unit configured to control the binding unit to perform binding processing for binding a plurality of sheets on which images are printed by the printing unit;
a specifying unit configured to specify a sheet to be used for printing; and
a notification unit configured to notify a user of a sheet for which a maximum number of sheets that are bindable by the binding processing is greater than or equal to that for the sheet specified by the specifying unit.

2. The image processing apparatus according to claim 1, further comprising a determination unit configured to determine a sheet for which a maximum number of sheets that are bindable by the binding processing is greater than or equal to that for the sheet specified by the specifying unit based on a size or a type of the sheet specified by the specifying unit.

3. The image processing apparatus according to claim 1, further comprising:
a storage unit configured to store a maximum number of sheets that are bindable by the binding processing for each of the sheet specified by the user and at least one other sheet; and
a determination unit configured to refer to the maximum number of sheets that is stored in the storage unit, compare the maximum number of sheets corresponding to the sheet specified by the specifying unit and the maximum number of sheets corresponding to the at least one other sheet, and determine a sheet for which a maximum number of sheets that are bindable by the binding processing is greater than or equal to that for the sheet specified by the specifying unit.

4. The image processing apparatus according to claim 2, wherein the determination unit selects a sheet for which the maximum number of sheets that are bindable by the binding processing is largest, if there is a plurality of sheets for which the maximum number of sheets that are bindable by the binding processing is greater than or equal to that for the sheet specified by the specifying unit.

5. The image processing apparatus according to claim 1, wherein the binding processing binds sheets without use of staples, and
wherein the notification unit performs the notification if the binding processing is specified.

6. The image processing apparatus according to claim 1, wherein the image processing apparatus is connected to a sheet processing apparatus having a plurality of binding units including a first binding unit and a second binding unit, and
wherein the notification unit does not perform the notification if the binding processing by the first binding unit is specified, and performs the notification if the binding processing by the second binding unit is specified.

7. The image processing apparatus according to claim 6, wherein the first binding unit binds sheets with use of staples, and the second binding unit binds sheets without use of staples.

8. An image processing apparatus that prints an image on a sheet and controls a binding unit to bind a plurality of sheets, the image processing apparatus comprising:
a printing unit configured to print an image on a sheet;
a control unit configured to control the binding unit to perform binding processing for binding a plurality of sheets on which images are printed by the printing unit;
a specifying unit configured to specify a sheet to be used for printing; and
a notification unit configured to notify a user of a sheet for which a binding strength by the binding processing is greater than or equal to that for the sheet specified by the specifying unit.

9. The image processing apparatus according to claim 8, further comprising a determination unit configured to determine a sheet for which the binding strength by the binding processing is greater than or equal to that for the sheet specified by the specifying unit based on a size or a type of the sheet specified by the specifying unit.

10. The image processing apparatus according to claim 8, further comprising:
a storage unit configured to store the binding strength by the binding processing for each of the sheet specified by the user and at least one other sheet; and
a determination unit configured to refer to the binding strength stored in the storage unit, compare the binding strength corresponding to the sheet specified by the specifying unit and the binding strength corresponding to the at least one other sheet, and determine a sheet for which the binding strength by the binding processing is greater than or equal to that for the sheet specified by the specifying unit.

11. The image processing apparatus according to claim 9, wherein the determination unit selects a sheet for which the binding strength by the binding processing is strongest if there is a plurality of sheets for which the binding strength by the binding processing is greater than or equal to that for the sheet specified by the specifying unit.

12. The image processing apparatus according to claim 8, wherein the binding processing binds sheets without use of staples, and
wherein the notification unit performs the notification if the binding processing is specified.

13. The image processing apparatus according to claim 8, wherein the image processing apparatus is connected to a sheet processing apparatus having a plurality of binding units including a first binding unit and a second binding unit, and
wherein the notification unit does not perform the notification if the binding processing by the first binding unit is specified, and performs the notification if the binding unit by the second binding unit is specified.

14. The image processing apparatus according to claim 13, wherein the first binding unit binds sheets with use of staples, and the second binding unit binds sheets without use of staples.

15. A printing control apparatus that controls a printing unit configured to print an image on a sheet and a binding unit configured to bind a plurality of sheets, the printing control apparatus comprising:
a control unit configured to control the printing unit to print an image on a sheet, and control the binding unit to perform binding processing for binding a plurality of sheets on which images are printed by the printing unit;
a specifying unit configured to specify a sheet to be used for printing; and
a notification unit configured to notify a user of a sheet for which at least one of a maximum number of sheets that are bindable by the binding processing and a binding strength by the binding processing is greater than or equal to that for the sheet specified by the specifying unit.

16. An information processing apparatus that transmits print data to an image processing apparatus configured to print an image on a sheet and bind a plurality of sheets, the information processing apparatus comprising:
a transmission unit configured to transmit print data for printing an image on a sheet and performing binding processing for binding a plurality of sheets having images printed thereon to the image processing apparatus;
a specifying unit configured to specify a sheet to be used for printing; and
a notification unit configured to notify a user of a sheet for which at least one of a maximum number of sheets that are bindable by the binding processing and a binding strength by the binding processing is greater than or equal to that for the sheet specified by the specifying unit.

17. A method for controlling a printing unit configured to print an image on a sheet and a binding unit configured to bind a plurality of sheets, the method comprising:
controlling the printing unit to print an image on a sheet;
controlling the binding unit to perform binding processing for binding a plurality of sheets on which images are printed by the printing unit;
specifying a sheet to be used for printing; and
notifying a user of a sheet for which at least one of a maximum number of sheets that are bindable by the binding processing and a binding strength by the binding processing is greater than or equal to that for the specified sheet.

18. A non-transitory storage medium storing a program readable by a computer configured to control a printing unit configured to print an image on a sheet and a binding unit configured to bind a plurality of sheets, the program causing the computer to perform a method comprising:
controlling the printing unit to print an image on a sheet;
controlling the binding unit to perform binding processing for binding a plurality of sheets on which images are printed by the printing unit;
specifying a sheet to be used for printing; and
notifying a user of a sheet for which at least one of a maximum number of sheets that are bindable by the binding processing and a binding strength by the binding processing is greater than or equal to that for the specified sheet.

19. A non-transitory storage medium storing a program readable by a computer configured to transmit print data to an image processing apparatus configured to print an image on a sheet and bind a plurality of sheets, the program causing the computer to perform a method comprising:
transmitting print data for printing an image on a sheet and performing binding processing for binding a plurality of sheets on which images are printed to the image processing apparatus;
specifying a sheet to be used for printing; and
notifying a user of a sheet for which at least one of a maximum number of sheets that are bindable by the binding processing and a binding strength by the binding processing is greater than or equal to that for the specified sheet.
